(19) United States
(12) Patent Application Publication
(10) Pub. No.: US 2017/0174144 A1
(43) Pub. Date: Jun. 22, 2017

(54) Tool Box System

(71) Applicant: Roger Addison, Clewiston, FL (US)

(72) Inventor: Roger Addison, Clewiston, FL (US)

(21) Appl. No.: 14/973,917

(22) Filed: Dec. 18, 2015

(51) Int. Cl. B60R 9/06

(52) U.S. Cl. CPC B60R 9/065

(57) ABSTRACT

A tool box system for utilizing the space beneath a cross bed tool box in a vehicle includes a vehicle that has a bed. A first box is positioned within the bed. A second box is positioned between the first box and the bed.

### BACKGROUND OF THE DISCLOSURE

### Field of the Disclosure

The disclosure relates to tool box devices and more particularly pertains to a new tool box device for utilizing the space beneath a cross bed toolbox in a pickup.

### SUMMARY OF THE DISCLOSURE

An embodiment of the disclosure meets the needs presented above by generally comprising a vehicle that has a bed. A first box is positioned within the bed. A second box is positioned between the first box and the bed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a tool box system according to an embodiment of the disclosure.

FIG. 2 is a right side view of an embodiment of the disclosure.

FIG. 3 is a cross sectional view taken along line 3-3 of FIG. 2 of an embodiment of the disclosure.

FIG. 4 is a front exploded view of an embodiment of the disclosure.

FIG. 5 is a perspective in-use view of an embodiment of the disclosure.

### DESCRIPTION OF THE PREFERRED EMBODIMENT

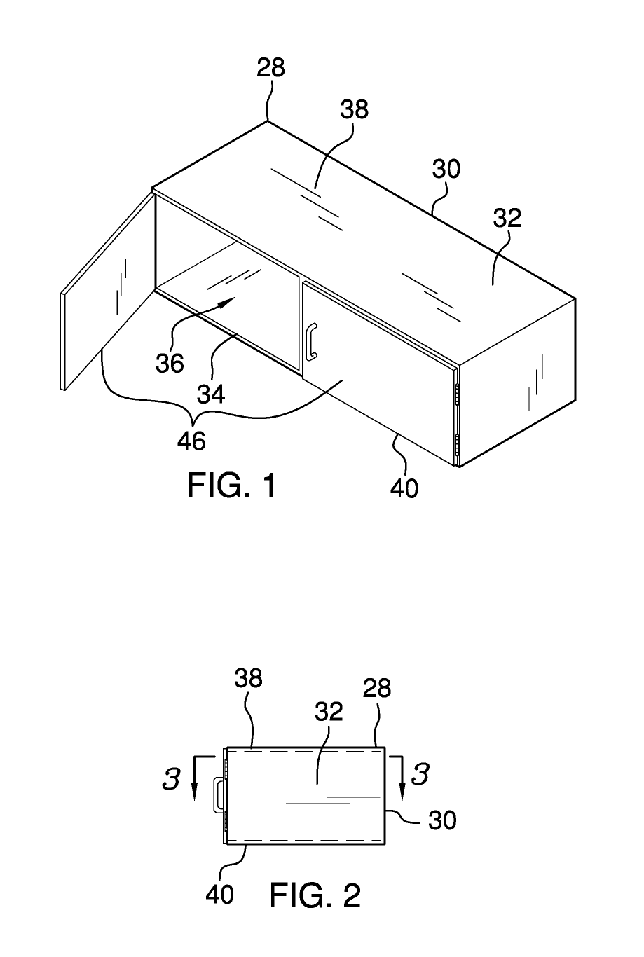

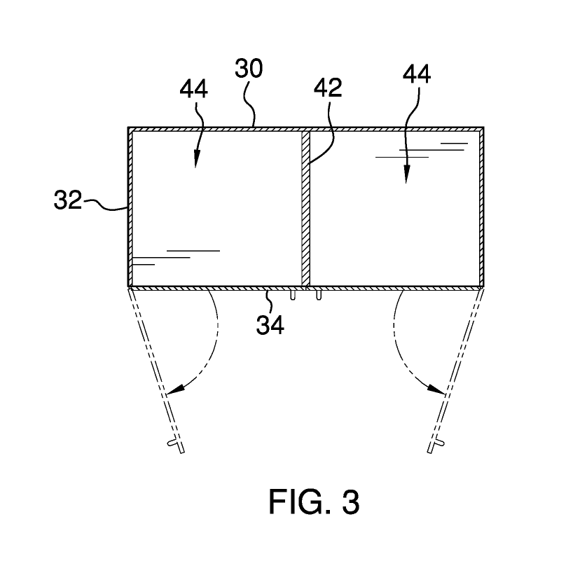

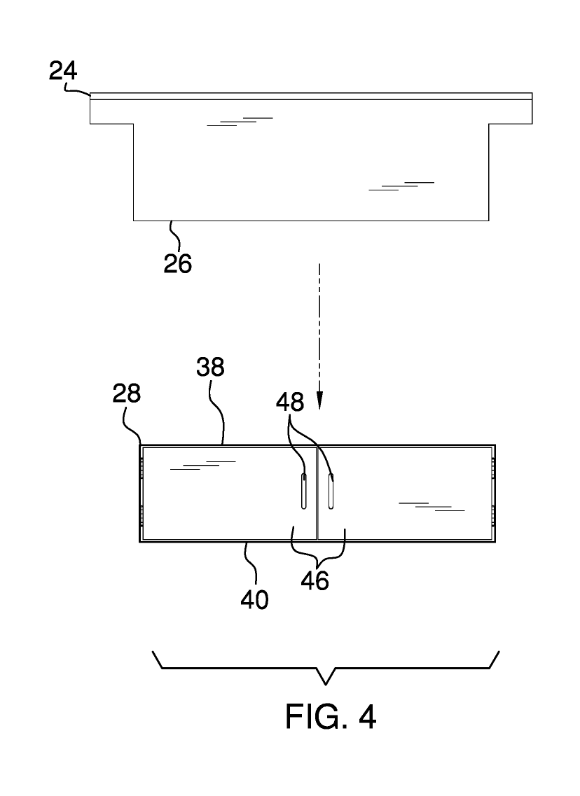

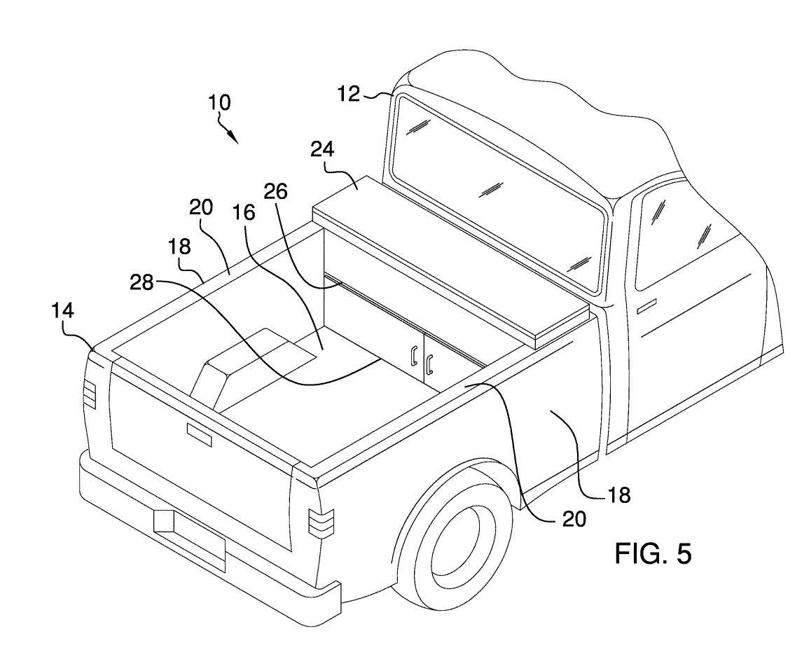

With reference now to the drawings, and in particular to FIGS. 1 through 5 thereof, a new tool box device embodying the principles and concepts of an embodiment of the disclosure and generally designated by the reference numeral 10 will be described.

As best illustrated in FIGS. 1 through 5, the tool box system 10 generally comprises a vehicle 12 that has a bed 14. The bed 14 has a basal wall 16 and a pair of pair of lateral walls 18 extending upwardly from the basal wall 16. The lateral walls 18 are spaced from each other and each of the lateral walls 18 has a distal edge 20 with respect to the basal wall 16. The vehicle 12 may be a pickup or the like.

A first box 24 is positioned within the bed 14 and the first box 24 may contain objects. The first box 24 has a bottom wall 26. The first box 24 extends between the lateral walls 18. The first box 24 may rest on the distal edge 20 of each of the lateral walls 18. The bottom wall 26 is spaced from the basal wall 16 of the bed 14 and the first box 24 may be a cross bed tool box or the like.

A second box 28 is positioned between the first box 24 and the bed 14 and the second box 28 may contain objects. The second box 28 has a back wall 30 and a peripheral wall 32 extending forwardly from the back wall 30. The peripheral wall 32 has a distal edge 34 with respect to the back wall 30 and the distal edge 34 defines an opening 36 into an interior of the second box 28.

The peripheral wall 32 has a top side 38 and a bottom side 40. The bottom side 40 abuts the basal wall 16 of the bed 14 such that the second box 28 extends between the lateral walls 18 of the bed 14. The top side 38 is positioned beneath the bottom wall 26 of the first box 24. The second box 28 has a divider 42 extending forwardly from the back wall 30. The divider 42 is centrally positioned within the second box 28 to define a pair of spaces 44 within the second box 28.

A pair of doors 46 is provided. Each of the doors 46 is hingedly coupled to the second box 28. Each of the doors is positioned on the distal edge 34 of the second box 28. Each of the doors 46 is positionable in a closed position such that each of the doors 46 closes an associated one of the spaces 44. A pair of handles 48 is provided. Each of the handles 48 is coupled to an associated one of the doors 46 and each of the handles 48 may be gripped to manipulate the doors 46.

In use, the second box 28 is positioned beneath the first box 24. Each of the first box 24 and the second box 28 are filled objects. The second box 28 facilitates the space beneath the first box 24 to be used for storage. The second box 28 may be utilized independently of the first box 24.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A tool box system comprising:
a vehicle having a bed;
a first box being positioned within said bed wherein said first box is configured to contain objects; and
a second box being positioned between said first box and said bed wherein said second box is configured to contain objects, said second box being separate from said first box wherein said first box and said second box are independently separable from said vehicle.

2. The system according to claim 1, wherein:
said bed has a basal wall and a pair of pair of lateral walls extending upwardly from said basal wall, said lateral walls being spaced from each other; and
said first box having a bottom wall, said first box extending between said lateral walls, said bottom wall being spaced from said basal wall of said bed.

3. The system according to claim 2, wherein said second box has a back wall and a peripheral wall extending forwardly from said back wall, said peripheral wall having a distal edge with respect to said back wall, said distal edge defining an opening into an interior of said second box, said peripheral wall having a top side and a bottom side, said bottom side abutting said basal wall of said bed while said second box is positioned under said first box and said first box is supported on said lateral walls of said bed, said second box being sized such that said second box extends between said lateral walls of said bed.

4. The system according to claim 3, wherein said second box has a divider extending forwardly from said back wall, said divider being centrally positioned within said second box to define a pair of spaces within said second box.

5. The system according to claim 1, wherein:
said second box having a front side and a pair of spaces; and
a pair of doors, each of said doors being hingedly coupled to said second box, each of said doors being positioned on said front side, each of said doors being positionable in a closed position such that each of said doors closes an associated one of said spaces.

6. A tool box system comprising:
a vehicle having a bed, said bed having a basal wall and a pair of pair of lateral walls extending upwardly from said basal wall, said lateral walls being spaced from each other;
a first box being positioned within said bed wherein said first box is configured to contain objects, said first box having a bottom wall, said first box extending between said lateral walls, said bottom wall being spaced from said basal wall of said bed;
a second box being positioned between said first box and said bed wherein said second box is configured to contain objects, said second box being separate from said first box wherein said first box and said second box are independently separable from said vehicle, said second box having a back wall and a peripheral wall extending forwardly from said back wall, said peripheral wall having a distal edge with respect to said back wall, said distal edge defining an opening into an interior of said second box, said peripheral wall having a top side and a bottom side, said bottom side abutting said basal wall of said bed while said second box is positioned under said first box and said first box is supported on said lateral walls of said bed, said second box being sized such that said second box extends between said lateral walls of said bed, said second box having a divider extending forwardly from said back wall, said divider being centrally positioned within said second box to define a pair of spaces within said second box; and
a pair of doors, each of said doors being hingedly coupled to said second box, each of said doors being positioned on said front side, each of said doors being positionable in a closed position such that each of said doors closes an associated one of said spaces.
